(19) United States
(12) Patent Application Publication
(10) Pub. No.: US 2026/0312613 A1
(43) Pub. Date: Oct. 8, 2026

(54) Wireless Scour Detection System with Remote Vibration Sensing via ESP32 and ESP-NOW

(71) Applicants: Alan Kazemian, Powder Springs, GA (US); Joe Kazemian, Powder Springs, GA (US); Jane Kazemian, Powder Springs, GA (US); Andrew Kazemian, Powder Springs, GA (US); Charisse Kazemian, Powder Springs, GA (US)

(72) Inventors: Alan Kazemian, Powder Springs, GA (US); Joe Kazemian, Powder Springs, GA (US); Jane Kazemian, Powder Springs, GA (US); Andrew Kazemian, Powder Springs, GA (US); Charisse Kazemian, Powder Springs, GA (US)

(21) Appl. No.: 19/098,558

(22) Filed: Apr. 2, 2025

(51) Int. Cl. H04B 1/40; G01M 5/00; G01N 17/00

(52) U.S. Cl. CPC H04B 1/40; G01M 5/0066; G01N 17/00

(57) ABSTRACT

The invention provides a wireless scour detection system for monitoring vibrations in structures such as bridges using either multiple accelerometers (larger system) or a single accelerometer (smaller system). The system uses ESP32 modules, the ESP-NOW protocol, and deep sleep functionality for low power consumption. The transmitter sends vibration data to a receiver, which logs the data and sends it to a remote server via cellular communication. The system's compact design allows for long-lasting, remote monitoring of structural health, detecting anomalies like scour in real-time.

### DETAILED DESCRIPTION OF THE INVENTION

### 1. Field of the Invention

This invention pertains to the field of remote monitoring and wireless communication systems, specifically for detecting scour and monitoring vibrations in structural systems such as bridges and machines. More particularly, the invention relates to a wireless system utilizing accelerometers, ESP32 modules, and the ESP-NOW communication protocol to collect and transmit vibration data, providing real-time insights on structural integrity, particularly in locations where access and power supply are limited.

### 2. Background of the Invention

2A. In structural monitoring, particularly for critical infrastructure like bridges, continuous vibration monitoring is essential for detecting early signs of damage or scour caused by water erosion. Existing systems often rely on wired solutions or traditional wireless communication protocols, which can be costly and difficult to maintain in remote or hard-to-reach locations. Furthermore, battery-powered monitoring systems often suffer from short lifespans due to high power consumption.

2B. This invention solves these problems by utilizing the ESP32 module, which features low-power deep sleep functionality, combined with the ESP-NOW protocol for efficient wireless communication. The system is designed for long-term, low-maintenance operation, using a rechargeable LiPo battery that can last up to 10 years or more, depending on battery size and usage. This invention also incorporates advanced vibration detection using accelerometers, providing highly accurate and timely data on the state of the monitored structure. Specifically, the system detects changes in vibration patterns, which are indicative of structural damage or scour.

### 3. Summary of the Invention

3A. The present invention is a wireless scour detection system that uses either a set of six ADXL345 accelerometers, a TCA9548A multiplexer, and an ESP32 module to monitor vibrations on structures like bridges (the larger system), or alternatively a simpler configuration of a single ADXL345 accelerometer, a DS3231 real-time clock, and a single ESP32 module (the smaller system). The system is powered by a 3.7 4000 mAh rechargeable LiPo battery and employs deep sleep functionality for power conservation, ensuring long-lasting operation. The collected vibration data, along with timestamped temperature information from the DS3231 real-time clock, is transmitted to a receiver using the ESP-NOW protocol.

3B. The receiver, equipped with a SIM 7000G module and an SD card, receives the transmitted data, logs it locally on the SD card, and can send the data to a remote server using cellular communication. The receiver may also utilize alternative power sources such as a 9V/12V battery with an PWM/MPPT charge controller and a solar panel, allowing for extended operation in remote environments. The system's ability to take rapid or slow samples, along with onboard FFT (Fast Fourier Transform) processing for acceleration data, makes it a powerful tool for analyzing and detecting structural anomalies in real-time, such as those caused by scour or vibration shifts due to environmental factors.

3C. Additionally, all system components are designed to be removable, allowing for easy replacement and maintenance should any component fail or require an upgrade.

### 4. SYSTEM DIAGRAMS

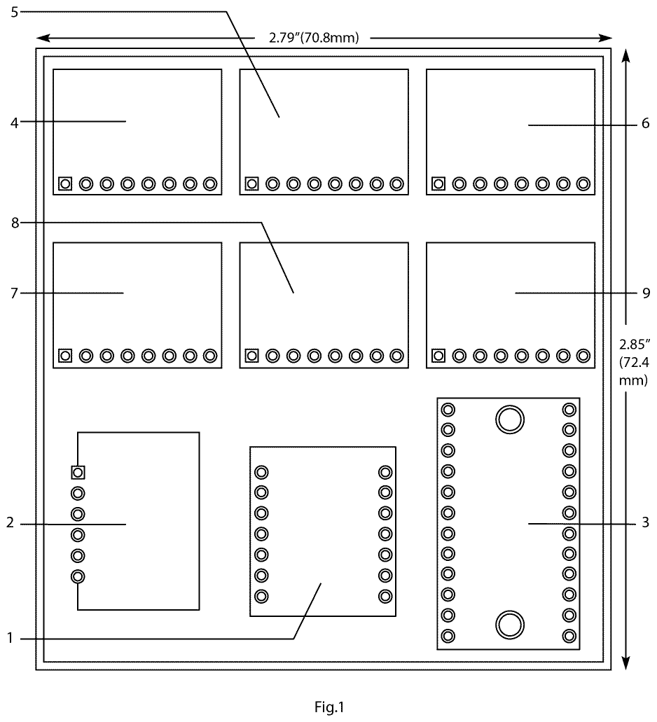

4A. FIG. 1: Transmitter (Larger System)

The first transmitter consists of nine components, designed to monitor vibrations at multiple points on a structure. These components include:
1. ESP32 Xaio Module (1)—The primary processing unit responsible for managing sensor data, processing signals, and transmitting data via ESP-NOW.
2. DS3231 Real-Time Clock/Temperature Sensor (2)—Provides precise timestamps for each data sample and monitors temperature changes that could affect accelerometer readings.
3. TCA9548A Multiplexer (3)—Manages communication with multiple I2C devices, allowing six accelerometers to function simultaneously without address conflicts. 4-9. Six ADXL345 Accelerometers (4-9)—Strategically placed to detect vibrations at different structural points. They can function independently or work together to provide a more comprehensive analysis of structural movement and potential scour effects.

4B. The transmitter is powered by a 3.7V 4000 mAh LiPo battery with deep sleep functionality, ensuring long operational lifespan. Data is transmitted to the receiver via ESP-NOW.

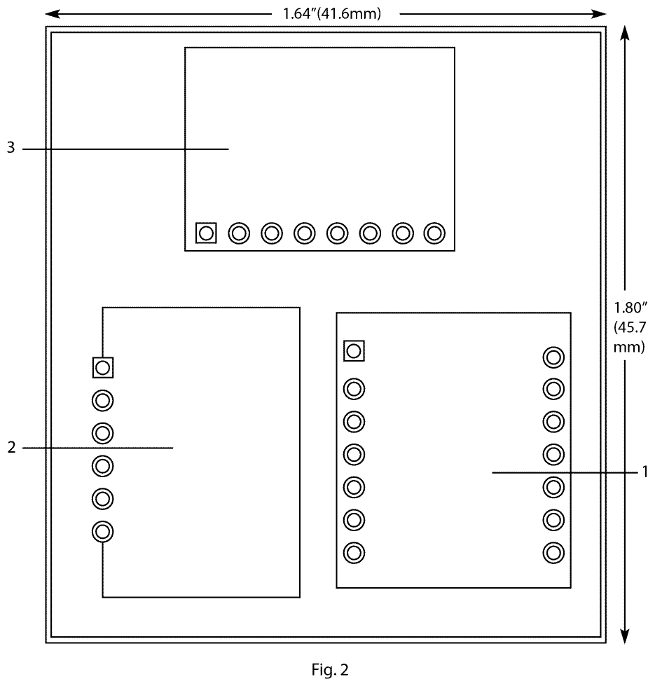

4C. FIG. 2: Transmitter (Smaller System)

A second transmitter is designed as a standalone version of the first, with fewer components for more compact monitoring applications. This transmitter contains:
4. ESP32 Xaio Module (1)—Handles sensor data processing and wireless transmission.
5. DS3231 Real-Time Clock/Temperature Sensor (2)—Provides timestamping and temperature monitoring.
6. Single ADXL345 Accelerometer (3)—Measures vibrations at a single point, making it suitable for smaller-scale applications such as monitoring individual machines or localized structural points.

4D. This smaller transmitter can operate independently or in conjunction with the larger system. It is designed for low power consumption, utilizing deep sleep mode to maximize battery life.

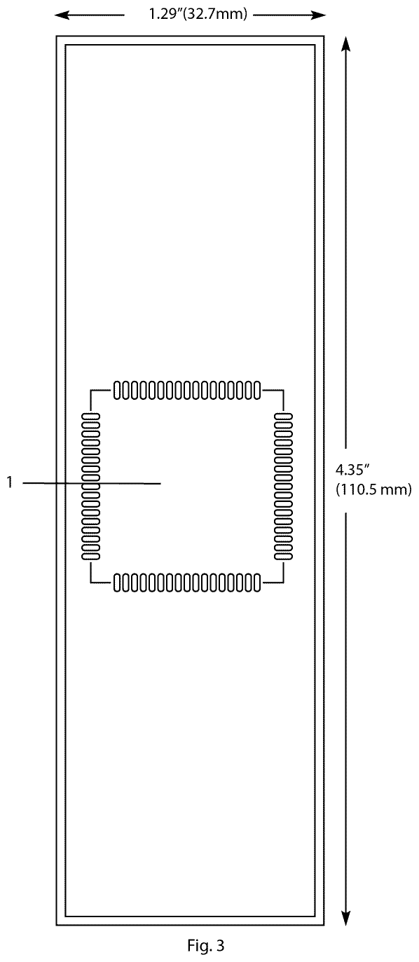

4E. FIG. 3: Receiver Unit

The receiver collects and processes data from one or more transmitters. It consists of the following components:
7. ESP32 Module (1)—The primary processing unit that handles incoming data, performs analysis, and manages communication. The receiver may also incorporate additional components such as a SIM7000 cellular module for remote data transmission, an SD card for local storage, and an optional solar panel connection for long-term operation. It may also include an MPPT charge controller for managing solar energy and a 12V battery for extended operation. 4F. The receiver processes incoming vibration data and performs FFT (Fast Fourier Transform) analysis to detect structural anomalies, such as those caused by scour or environmental changes. Data can be accessed remotely via cellular communication, reducing the need for physical inspections and maintenance.

1. A Wireless Scour Detection System, Comprising: A. A transmitter with an ESP32 module, multiple ADXL345 accelerometers managed by a TCA9548A multiplexer, and a DS3231 real-time clock for vibration and temperature monitoring;
B. A power-efficient design using a 3.7 4000mAh LiPo battery with deep sleep functionality for extended operational lifespan;
C. Data transmission via ESP-NOW to a receiver for remote structural monitoring;
D. The ability to integrate alternative scour detection sensors, including but not limited to sonar-based sensors, ensuring comprehensive scour detection beyond vibration analysis;
E. All components are designed to be removable for easy replacement and maintenance;
F. A configuration wherein multiple transmitters may work together, transmitting their data to a single receiver, or a configuration where each transmitter and receiver operate independently, allowing flexibility for system deployment.

2. A Receiver for Remote Data Processing and Transmission, Comprising: A. An ESP32 module receiving data from the transmitter, logging it on an SD card, and sending it to a remote server via a SIM7000G cellular module;
B. Onboard FFT processing for detecting structural anomalies, optimizing data analysis for scour and vibration shifts;
C. A solar-powered option with an MPPT charge controller and a 12V battery for sustainable, long-term deployment.

3. A Compact Wireless Monitoring System, Comprising: A. A simplified transmitter with an ESP32 module, a single ADXL345 accelerometer, and a DS3231 real-time clock for smaller-scale applications;
B. Low-power operation with deep sleep mode, supporting up to 10 years of battery life;
C. Data transmission via ESP-NOW, with the receiver handling storage and remote server communication;
D. Protection against the addition of a second SIM7000G module for storing data, not for communication;
E. Protection against modifications that would require the system to work via wired connections instead of wireless ESP-NOW communication.
